(19) United States
(12) Patent Application Publication
(10) Pub. No.: US 2005/0067906 A1
(43) Pub. Date: Mar. 31, 2005

(54) Electric machine

(75) Inventors: Hubert Schierling, Erlangen (DE); Gunter Schwesig, Erlangen (DE)

Correspondence Address: HENRY M FEIEREISEN, LLC, 350 FIFTH AVENUE, SUITE 4714, NEW YORK, NY, 10118, US

(73) Assignee: SIEMENS AKTIENGESELLSCHAFT, Munchen (DE)

(21) Appl. No.: 10/953,862

(22) Filed: Sep. 29, 2004

(30) Foreign Application Priority Data
Sep. 30, 2003 (DE) 103 45 891.3

(51) Int. Cl. H02K 9/00; H02P 15/00

(52) U.S. Cl. 310/62; 310/58; 310/104

(57) ABSTRACT

An electric machine includes a housing, and a fan assembly having a fan and a drive unit for operating the fan. The drive unit has an air gap, wherein at least part of the air gap is positioned outside the housing and wherein at least part of the drive unit is positioned inside the housing.

### CROSS-REFERENCES TO RELATED APPLICATIONS

This application claims the priority of German Patent Application, Serial No. 103 45 891.3, filed Sep. 30, 2003, pursuant to 35 U.S.C. 119(a)-(d), the disclosure of which is incorporated herein by reference.

### BACKGROUND OF THE INVENTION

The present invention relates, in general, to the field of electric machines.

Nothing in the following discussion of the state of the art is to be construed as an admission of prior art.

Electric machines typically are constructed to have particular protection features such as protection against accidental contact, protection against ingress of foreign bodies, water protection, or explosion protection. Protected electric machines of these types are characterized by protection standards. For example, these standards are established according to DIN-VDE 0530 and EN 60035, part 5. Classification with designation character IP use numbers, whereby a first number relates to contact protection and protection against foreign bodies, whereas a second number relates to water protection. For example a motor may have a classification of IP54. The following table illustrates the classification according to designation character IP:

| First Number | Protection against contact and against foreign bodies |
|---|---|
| 0 | No protection |
| 1 | Protection against large-sized foreign bodies (0 greater |
| | than 50 mm |
| 2 | Protection against medium-sized foreign bodies |
| | (0 greater than 12 mm |
| 3 | Protection against small-sized foreign bodies (0 greater |
| | than 2.5 mm |
| 4 | Protection against granular foreign bodies |
| | (0 greater than 1 mm |
| 5 | Protection against large damaging powder deposits |
| 6 | Protection against penetration of dust |
| Second Number | Protection against water |
| 0 | No protection |
| 1 | Protection against the vertical fall of water drops |
| 2 | Protection against the fall of water drops with inclina- |
| | tion of maximum 15° in relation to the vertical |
| 3 | Protection against spray water with inclination of |
| | maximum 60° in relation to the vertical |
| 4 | Protection against water sprays from all directions |
| 5 | Protection against water jets from all directions |
| 6 | Protection against flooding |
| 7 | Protection against the effects of immersion |
| 8 | Protection against the effects of submersion |

To ensure clarity, it is necessary to establish the definition of several important terms and expressions that will be used throughout this disclosure. The term “own fan” relates to the arrangement of a fan which is in direct connection with the motor of the electric machine. In other words, the fan with its blades is mounted onto the shaft which represents at the same time the motor shaft so that a rotation of the motor results in a simultaneous rotation of the fan. The term “separate fan” or “separate fan assembly” relates to the arrangement of a fan which is operated by a separate motor independently of the motor of the electric machine. The term “rotor” is used here in a generic sense and relates to any moving member in relation to a stationary member (stator).

FIG. 1 shows an example of a conventional electric machine 2 having an own fan 19 to provide a cooling of the electric machine. The fan 19 has blades 9 which are mounted onto a shaft 37, whereby the shaft 37 represents the motor shaft of the electric machine 2 and is connected to a rotor 33 of the electric machine, such as e.g. a motor. The electric machine 2 has a housing 5 which represents the motor housing. Part of the motor housing 5 is formed by a bearing plate 4 for securement of a bearing 39 for the shaft 37. When electric machines of high protection standard are involved, the use of a cooling system with own fan becomes, however, very complex. Reference is made, for example, to Russian publication in RU 2 094 929 C1 which relates to an explosion-resistant electric machine. Another problem associated with the use of an own fans is encountered, when the electric machine runs with small rotation speed because the low rotation speed results in little cooling action. However, the efficiency of an electric machine increases with increase in the cooling action of the electric machine.

To address these problems, the application of a separate fan assembly has been proposed, generally designated by reference numeral 7 and shown in FIG. 2. The fan assembly 7 includes blades 9 which are mounted on a shaft 38 and an electric drive 22 for operating the blades. The drive 22 is disposed inside a housing 5 of an electric motor 6, representing an electric machine, and has an electric connection 23 for connection to a power supply. Thus, the electric drive 22 is disposed inside the housing 5 and only the shaft 38 extends outwards. FIG. 3 shows the provision of a separate fan assembly 7 which is disposed outside the housing 5. Seal 24 seals the interior of the fan assembly 7 against the outside and is wrapped around the connection 23.

The use of a separate fan assembly 7, as shown in FIGS. 2 and 3 requires also the provision of a protection standard analogous to the protection standard of the electric machine being cooled.

It would be desirable and advantageous to provide an improved electric machine to obviate prior art shortcomings and to include a cooling system which is simple in structure while still allowing a high degree of protection.

### SUMMARY OF THE INVENTION

According to one aspect of the present invention, electric machine includes a housing, and a fan assembly having a fan and a drive unit for operating the fan. The drive unit has an air gap, wherein at least part of the air gap is positioned outside the housing and wherein at least part of the drive unit is positioned inside the housing.

In accordance with the present invention, the part of the drive unit inside the electric machine includes in particular all live components of the drive unit which are situated within the protective zone of the housing of the electric machine. As a portion of the air gap is situated outside the housing of the electric machine, it is thus possible to construct the drive unit of the fan in such a manner that those parts of the drive unit, which are substantially determinative for the protection standard—especially for a high degree of protection—of the electric machine and would have an adverse effect on the protection, are placed inside the housing of the electric machine.

According to another feature of the present invention, the housing may be of single-piece configuration or of multi-part configuration.

The fan concept is especially applicable for decentralized driving technique in which a power converter is integrated in a motor or motor housing.

According to another feature of the present invention, the drive unit may be a magnetic coupling. As the fan is self-propelling by a rotor of the electric machine, the fan is considered an own fan.

According to another feature of the present invention, the fan may be a separate fan, with the drive unit being implemented as electric motor. The electric motor as drive unit of the separate fan has hereby an electric connection which can be so configured, when electric machine of high degree of protection are involved, that the electric connection does not adversely affect the entire protection standard of the electric machine.

According to another feature of the present invention, the electric motor of the separate fan may include a stator (hereinafter called “fan stator”) and a rotor (hereinafter called “fan rotor”), with the fan rotor positioned outside of the housing. Suitably, at least part of the fan stator can be positioned inside the housing. An air gap between the fan stator and the fan rotor is provided in the area of the electric machine in which the housing extends. The housing may hereby be so configured as to have parts that extend in the air gap.

According to another feature of the present invention, the housing can be so configured as to connect to end surfaces of the fan stator of the electric motor for the separate fan so that the fan stator forms part of the housing of the electric machine.

According to another feature of the present invention, the fan stator of the electric motor may be disposed inside the housing of the electric machine or at least partly disposed within the housing of the electric machine. When positioned at least partly within the housing, the housing is extended and thus does not extend flush with a top surface of the fan stator of the electric motor for the separate fan but is disposed adjacent to an inner side surface of the fan stator.

According to another feature of the present invention, the housing of the electric machine may be provided at both end surfaces of the fan stator of the electric motor for the separate fan or only at one end surface thereof. In the latter case, the electric connection of the electric motor of the separate fan is positioned inside the housing of the electric machine.

According to another feature of the present invention, the fan stator may have a base insulation and an additional insulation, with the additional insulation realized by a portion of the housing.

According to another feature of the present invention, the housing of the electric machine may accommodate an additional electric device which may be a power converter or an electronic drive assembly. In this way, the protection standard of the electric machine may be expanded to cover further electric devices or components. This reduces costs as the need for complicated housings for further electric devices is eliminated.

According to another feature of the present invention, the separate fan has blades which can be mechanically coupled with the fan rotor of the separate fan, whereby the separate fan may Include an enclosure, at least in an area of the blades for protection. The enclosure provides protection against foreign bodies as well as protection against accidental contact and resultant injury to persons. Suitably, the enclosure has slots or openings for passage of air.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 is a schematic illustration of a first conventional fan assembly;

FIG. 2 is a schematic illustration of a second conventional fan assembly;

FIG. 3 is a schematic illustration of a third conventional fan assembly;

FIG. 4 is a schematic fragmentary illustration of a first embodiment of an electric machine according to the present invention;

FIG. 5 is a schematic fragmentary illustration of a second embodiment of an electric machine according to the present invention;

FIG. 6 is a schematic fragmentary illustration of a third embodiment of an electric machine according to the present invention;

FIG. 7 is a schematic fragmentary illustration of a fourth embodiment of an electric machine according to the present invention; and

FIG. 8 is a schematic fragmentary illustration of a fifth embodiment of an electric machine according to the present invention.

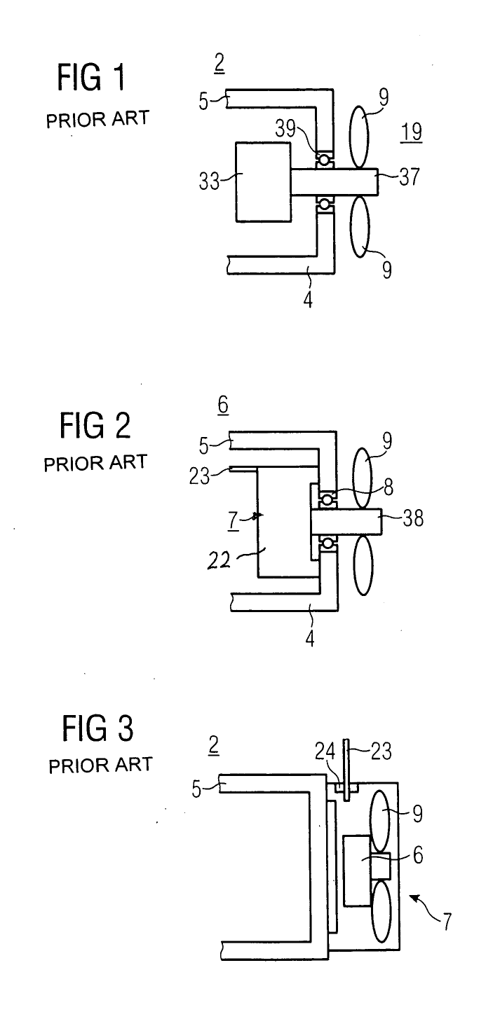

### DETAILED DESCRIPTION OF PREFERRED EMBODIMENTS

Throughout all the Figures, same or corresponding elements are generally indicated by same reference numbers. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

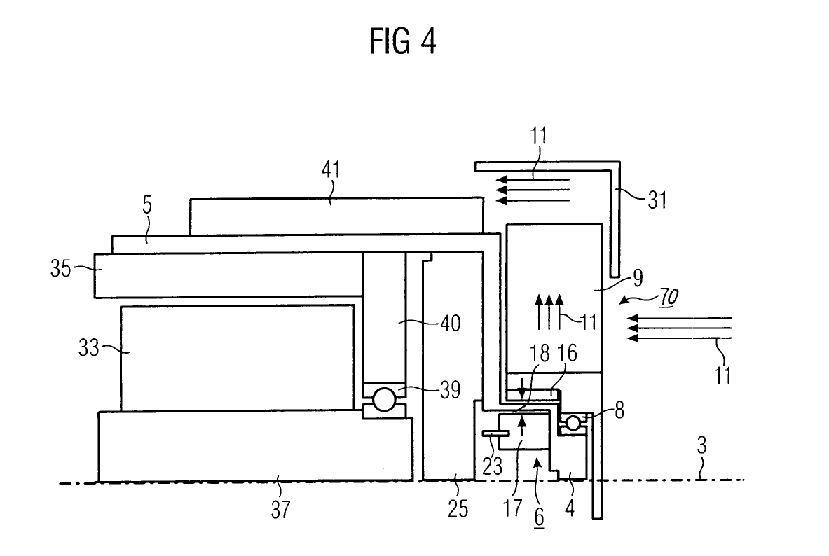

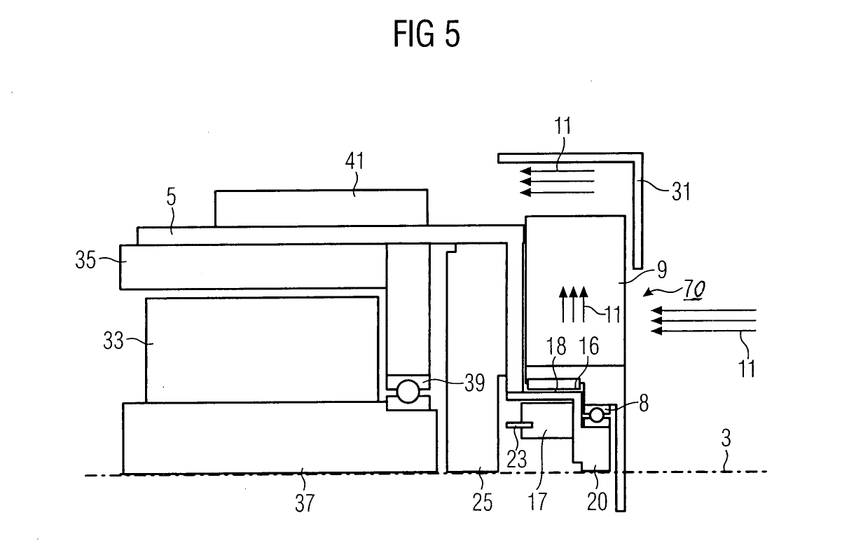

Turning now to the drawing, and in particular to FIG. 4, there is shown a schematic fragmentary illustration of a first embodiment of an electric machine according to the present invention, generally designated by reference numeral 1. The electric machine 1 may, for example, be constructed as asynchronous machine or permanent-magnet excited synchronous machine, and includes a stator 35 (hereinafter called “machine stator”) and a rotor 33 (hereinafter called “machine rotor”).

The machine rotor 33 is rotatably supported on a shaft 37 through intervention of a bearing unit 39 which is secured to a bearing plate 40. The electric machine 1 further includes a housing 5 which is formed with cooling fins 41 for improved cooling action. The housing 5 has accommodated therein an electronic drive assembly 25 and is so configured as to meet a particular protection standard for the electric machine 1.

The electric machine 1 is cooled by a separate fan assembly, generally designated by reference numeral 70 and including blades 9 for generating a flow of cooling air, as indicated by arrows 11. The cooling air 11 is hereby routed along the cooing fins 41. An enclosure 31 at least partly covers the blades 9 for protection. The separate fan assembly 70 further includes an electric motor 6 for operating the blades 9. The electric motor 6 includes a fan stator 17, having an electric connection 23, or connection to a power supply, and a fan rotor 16. Formed between the fan rotor 16 and the fan stator 17 is an air gap 18. The fan assembly 70 is supported by a bearing 8 for allowing a rotary movement, whereby the rotation axis of the fan assembly 70 and the rotation axis of the electric machine 1 coincide in a common machine axis 3.

The bearing 8 is protected here against external environmental impacts and does not assume any sealing functions against other components.

As shown in FIG. 4, the housing 5 extends through the air gap 18 thereby enhancing the protection of the electric machine 1. As the fan stator 17 of the electric motor 6 is provided with the electric connection 23, which thus is located inside the housing 5, and as the fan rotor 16 includes in particular permanent magnets and is disposed outside the housing 5, it is possible to determine the protection standard of the electric machine 1 by the housing 5, even though part of the electrically operated fan assembly 70 is located outside the housing 5 of the electric machine 1. The fan stator 17 of the electric motor 6 is hereby disposed within the electric machine 1 inside the housing 5, whereas the fan rotor 16 is disposed outside the electric machine 1, while part of the housing 5 is positioned between the fan stator 17 and the fan rotor 16. Suitably, the fan rotor 16 does not include any electronics and is provided with the permanent magnets. Outside the housing 5 of the electric machine, there are no components that require particular care in order to meet a particular protection standard for the electric machine 1.

FIG. 5 shows a schematic fragmentary illustration of a second embodiment of an electric machine according to the present invention, generally designated by reference numeral 1. Parts corresponding with those in FIG. 4 are denoted by identical reference numerals and not explained again. The description below will center on the differences between the embodiments. In this embodiment, provision is made for a bearing plate 20 which is constructed to extend through the air gap 18 of the electric motor 6 for the separate fan assembly 70, instead of the housing 5 of the electric machine 1 being routed through the air gap 18. The bearing plate 20 connects, however, to the housing 5. In other words, the housing 5 is continued by the bearing plate 20 which thus can be considered as part of the housing 5, so that, in fact, the housing 5 is here of multi-part configuration.

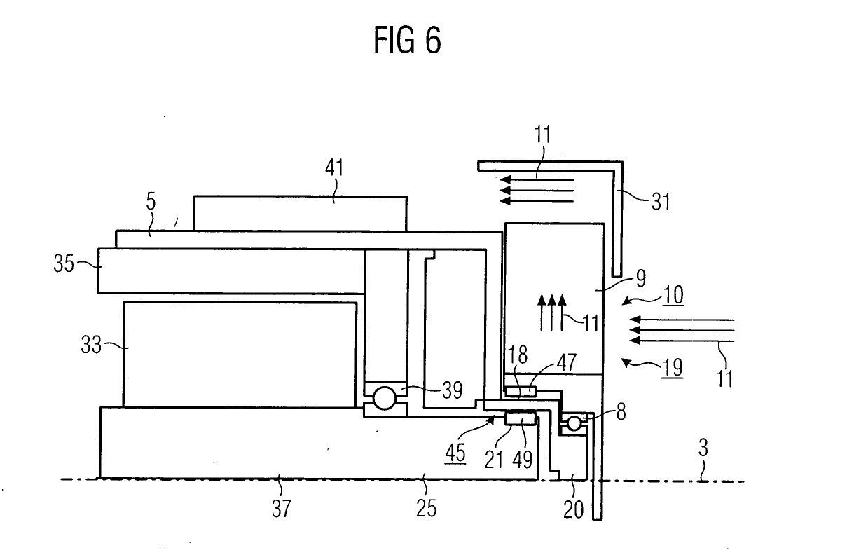

FIG. 6 shows a schematic fragmentary illustration of a third embodiment of an electric machine according to the present invention, generally designated by reference numeral 1. Parts corresponding with those in FIGS. 4 and 5 are denoted by identical reference numerals and not explained again. The description below will center on the differences between the embodiments. In this embodiment, provision is made for an own fan assembly, generally designated by reference numeral 19 for the electric machine 1. The fan assembly 19 includes blades 9 and a magnetic coupling 45 having primary permanent magnets 49, which are mounted on the motor shaft 37, and secondary permanent magnets 47, which are connected to a fan wheel, i.e. the blades 9. As the motor shaft 37 rotates, the magnetic field generated by the primary permanent magnets 49 moves the secondary permanent magnets 47. As a result, the blades 9 are caused to rotate. In other words, a rotation of the motor shaft 37 is translated into an operation of the fan 19. The bearing plate 20 again is routed through the air gap 18 and connects to the housing 5. Although not shown here, it is certainly within the scope of the invention to route the housing 5 through the air gap 18, as shown in FIG. 4.

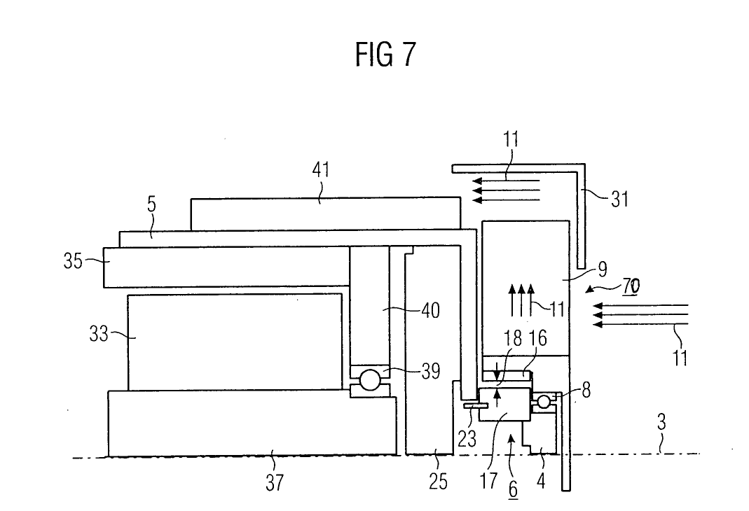

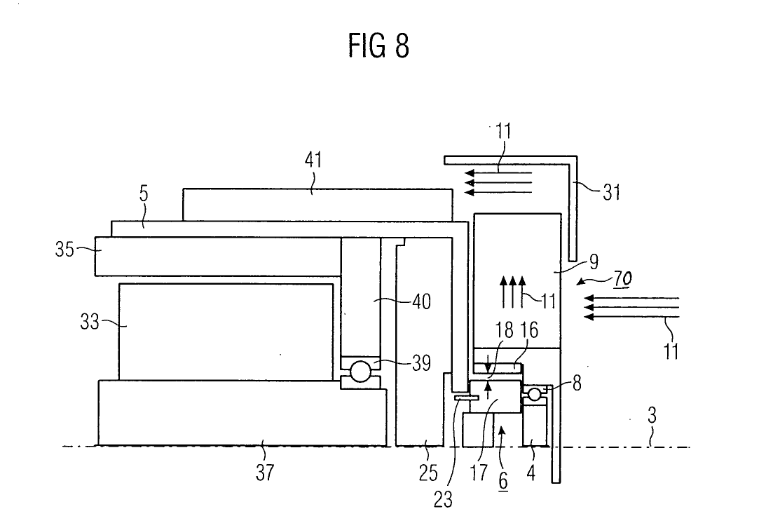

FIGS. 7 and 8 show further variations of an electric machine 1 with separate fan assembly 70. In FIG. 7, the housing 5 is extended in radial direction so as to extend adjacent an inner end surface of the fan stator 17 so that the fan stator 17 forms part of the housing 5 and together with the fan rotor 16 defines the air gap 18. FIG. 8 shows an embodiment in which the housing 5 is constructed to extend adjacent two end surfaces of the fan stator 17.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. An electric machine, comprising:
a housing;
a fan assembly including a fan and a drive unit for operating the fan, said drive having an air gap, wherein at least part of the air gap is positioned outside the housing, and wherein at least part of the drive unit is positioned inside the housing.

2. The electric machine of claim 1, wherein the drive unit is a magnetic coupling.

3. The electric machine of claim 1, wherein the fan assembly is a separate fan assembly, with the drive unit being implemented as electric motor.

4. The electric machine of claim 3, wherein the electric motor includes a fan stator and a fan rotor, with the fan rotor positioned outside of the housing.

5. The electric machine of claim 4, wherein at least part of the fan stator is positioned inside the housing.

6. The electric machine of claim 4, wherein the housing is constructed to extend adjacent to an inner side surface of the fan stator.

7. The electric machine of claim 1, wherein the housing is so configured as to have a housing portion which extends in the air gap.

8. The electric machine of claim 4, wherein the fan stator has a base insulation and an additional insulation, with the additional insulation established by a portion of the housing.

9. The electric machine of claim 4, wherein the fan stator is integrated in the housing.

10. The electric machine of claim 4, wherein the fan stator has an electric connection, with the electric connection positioned inside the housing.

11. The electric machine of claim 4, wherein the housing is constructed to extend adjacent an end surface of the fan stator so that the fan stator forms part of the housing of the electric machine.

12. The electric machine of claim 4, further comprising an additional electric device accommodated in the housing.

13. The electric machine of claim 12, wherein the additional electric device is a power converter.

14. The electric machine of claim 12, wherein the additional electric device is an electronic drive assembly.

15. The electric machine of claim 1, wherein the housing is of single-piece configuration.

16. The electric machine of claim 1, wherein the housing is of multi-part configuration.

17. The electric machine of claim 3, wherein the separate fan assembly has blades which are mechanically coupled with the fan rotor of the electric motor, said separate fan assembly including an enclosure at least in an area of the blades.

18. The electric machine of claim 17, wherein the enclosure has slots or openings for passage of air.
